(19) United States
(12) Patent Application Publication
(10) Pub. No.: US 2014/0222475 A1
(43) Pub. Date: Aug. 7, 2014

(54) FLIGHT SAVER SYSTEM

(71) Applicant: Neil ORKIN, Seminole, FL (US)

(72) Inventor: Neil ORKIN, Seminole, FL (US)

(21) Appl. No.: 13/760,705

(22) Filed: Feb. 6, 2013

(51) Int. Cl. G06Q 30/06

(52) U.S. Cl. CPC G06Q 30/0629
USPC 705/5; 705/26.64

(57) ABSTRACT

A fare searching system that includes a receiver configured to receive a fare request from a user device, the fare request including at least a source location, a destination location, and a time of departure. A transmitter that is configured to process the fare request and transmit a request for fare information regarding the fare request to an airline fare information system. A processor that is configured to process and compile a first list of fares received from the airline fare information system, wherein the processor is also configured to generate a second list of fares including fares in which an intermediate location is the source location and/or the destination location, and the processor generates a combined list of fares based on the first and second lists. The transmitter transmits the combined list to the user device.

### FIELD OF INVENTION

The subject matter disclosed herein relates to computer systems and data communication systems. More particularly, the subject matter disclosed herein is related to the electronic storage, communication, processing, and display of data related to the travel industry and more particularly related to a fare searching program and method that finds the lowest fare irrespective of demand based pricing.

### BACKGROUND

Airlines typically base airfare prices on demand and do not base airfare prices on costs. Airlines schedule flights and then adjust the prices to maximize the revenue based on demand. For example, if there is a higher demand for flights to location B than there is for location C, then a fare from location A to location B will generally be more expensive than a fare from location A to location C, which requires a layover and two flights, one from location A to location B and another from location B to location C. However, airlines and travel search engines do not allow users to search for these indirect flights.

Accordingly, there is a need for an improved searching program and method that overcomes the limitations of the prior art.

### SUMMARY

A fare searching system is disclosed that includes a receiver configured to receive a fare request from a user device, the fare request including at least a source location, a destination location, and a time of departure. A transmitter is configured to process the fare request and transmit a request for fare information regarding the fare request to an airline fare information system. A processor is configured to process and compile a first list of fares received from the airline fare information system, wherein the processor is also configured to generate a second list of fares including fares in which an intermediate location is the source location and/or the destination location, and the processor generates a combined list of fares based on the first and second lists. The transmitter transmits the combined list to the user device.

A fare searching method is disclosed that includes receiving a fare request from a user device, the fare request including at least a source location, a destination location, and a time of departure. The method includes processing the fare request and transmitting the request for fare information regarding the fare request to an airline fare information system. The method includes processing and compiling a first list of fares received from the airline fare information system. The method includes generating a second list of fares including fares in which an intermediate location is the source location and/or the destination location. The method includes generating a combined list of fares based on the first and second lists and sending the combined list to the user device.

### BRIEF DESCRIPTION OF THE DRAWINGS

FIGS. 1 and 3 are examples of user interfaces for a reservation system;

FIGS. 2 and 4 are examples of search results for fares;

FIG. 5 is a travel planning system according to an embodiment of the invention;

FIG. 6 is a travel search form according to an embodiment of the invention;

FIG. 7 is a flow diagram according to an embodiment of the invention;

FIGS. 8 and 9 are flow diagrams according to different embodiments of the invention; and

FIGS. 10a and 10b are a flow diagram of according to an embodiment of the invention.

### DETAILED DESCRIPTION

Disclosed herein are computer-implemented method, computing systems, and related technologies for determining a travel itinerary and booking said travel itinerary.

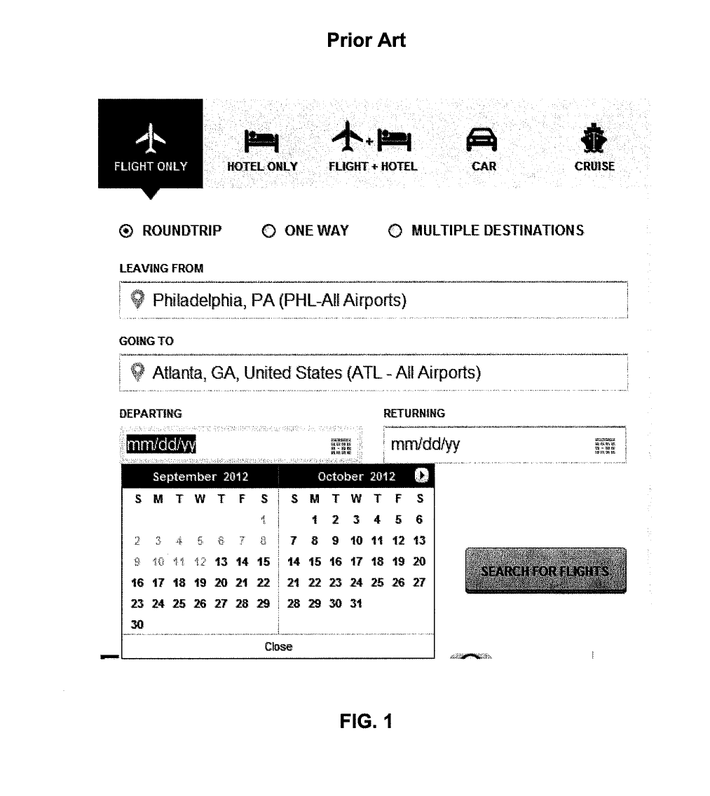

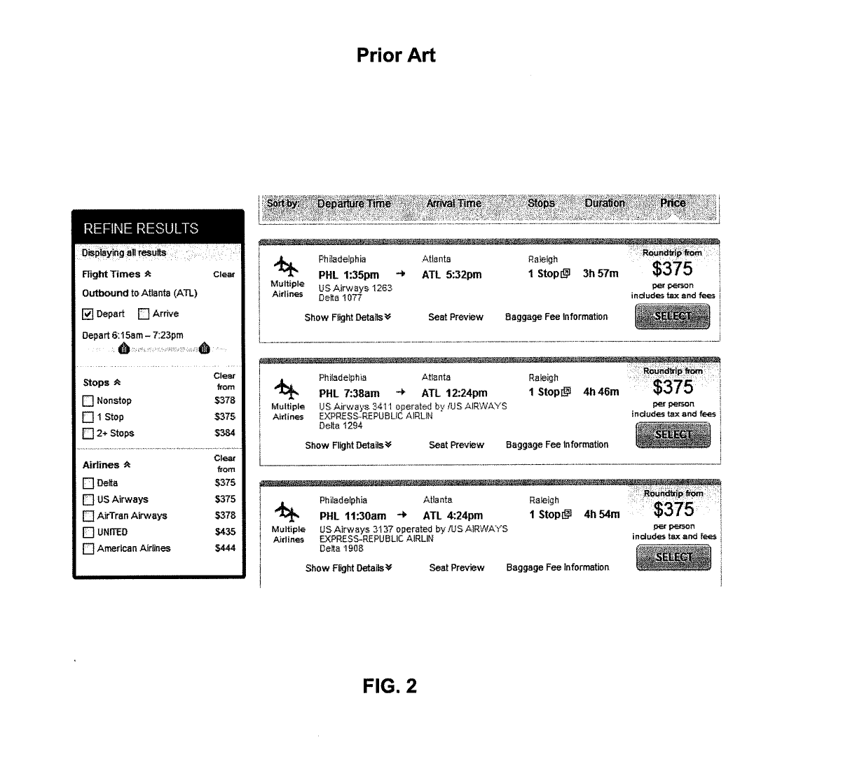

FIG. 1 shows an example user interface for a reservation system shown on a web page via a computer. As shown in FIG. 1, a user interested in traveling from Philadelphia to Atlanta enters the information using the interface, such as a website. The reservation system asks how many stops are acceptable during the trip. A user may select a direct flight or a flight with one or more stops. Reservation systems also require a user to enter the preferred origin city and destination city, along with times and dates of interest. Alternatively a user may enter an origin city and the system can present a list of flights available from that destination. In another alternative, the reservation system may ask whether the user's origin city and destination city are flexible. This allows a user to travel from or to a location near the selected location. In another embodiment, the reservation system may ask the user if the dates are flexible. This may allow the reservation system to search dates near the selected date. Once the user completes the presented form, the user submits the information. The information is then sent from the user's computer to the reservation system. The user is then presented with results, as shown in FIG. 2.

As shown FIG. 2, the user is presented with a list of travel itineraries. The rates for a particular itinerary may vary based on the time, the airline(s) selected, and the number of stops. A direct flight on a single airline is typically more expensive than an indirect flight that utilizes multiple airlines and flights. Conversely a user may save money by flying with one or more stops or with multiple airlines. At this point, the user can select a particular itinerary, or the user may be able to amend the search parameters (i.e. time, date, location) and receive new results. Once the user selects the results, the reservation system then communicates with the airline's reservation system and places a hold on the selected seat for a predetermined time. The user is then requested to provide payment for the ticket within a predetermined time. If the user pays, the reservation is complete and the ticket is reserved. If the user does not provide payment in the requested time, the airline's reservation system releases the hold on the selected seat.

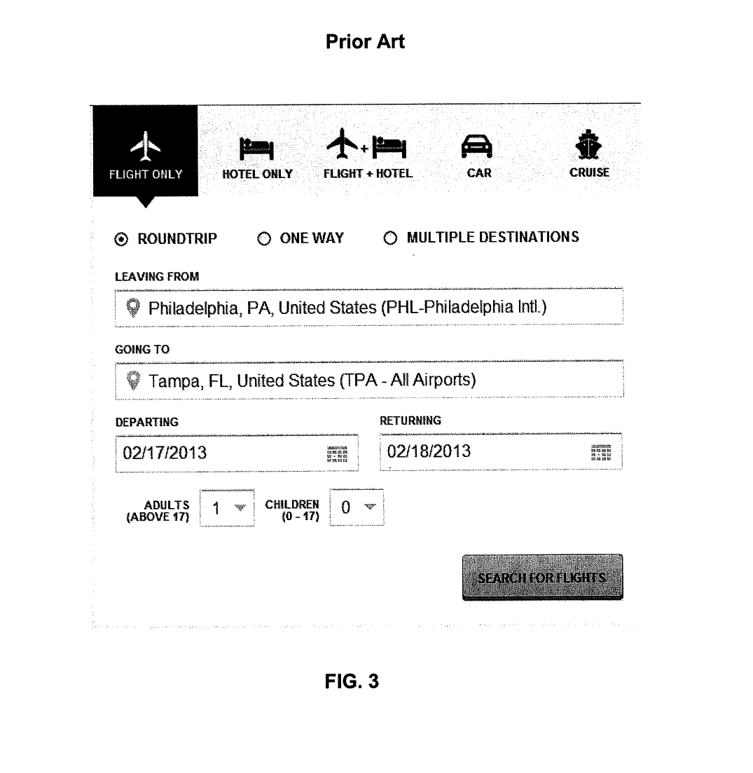

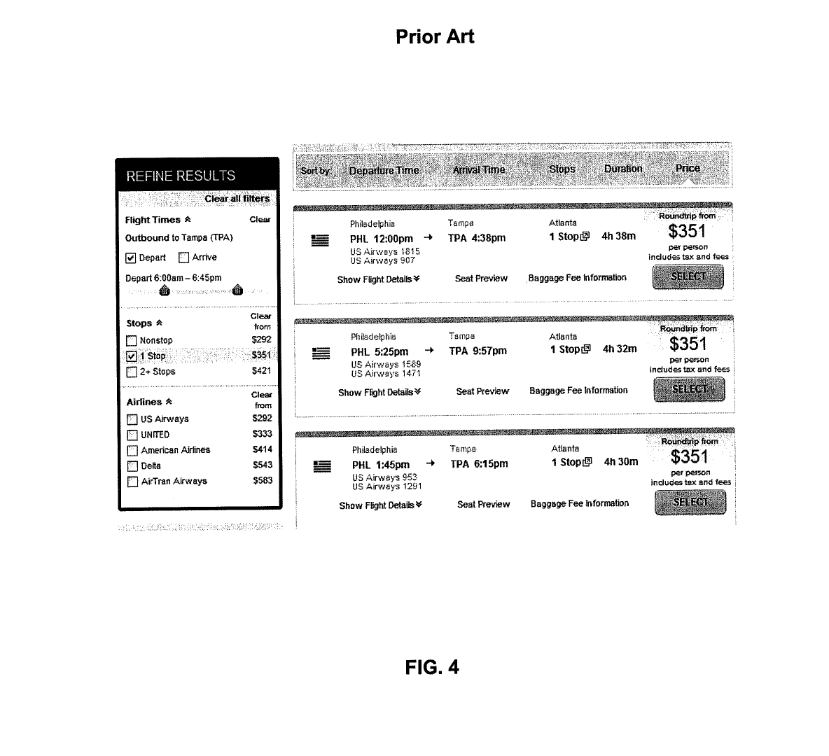

FIG. 3 shows another example interface for a reservation system. As seen from the information, the same user may search for a flight from Philadelphia to Tampa using the same input as above. FIG. 4 shows example search results for this itinerary. Similar to FIG. 2 above, FIG. 4 shows there are multiple flights at varying prices. However, the flights to Tampa are cheaper than flights to Atlanta. Some of the flights to Tampa include two indirect flights: one flight from Philadelphia to Atlanta, and another flight from Atlanta to Philadelphia. Many airlines do not base the price of a flight on costs. Airlines often price flights based on demand to maximize revenue. Because of this demand based pricing, a direct flight from Philadelphia to Atlanta may be more expensive than an indirect flight from Philadelphia to Tampa which includes and indirect flight to Atlanta.

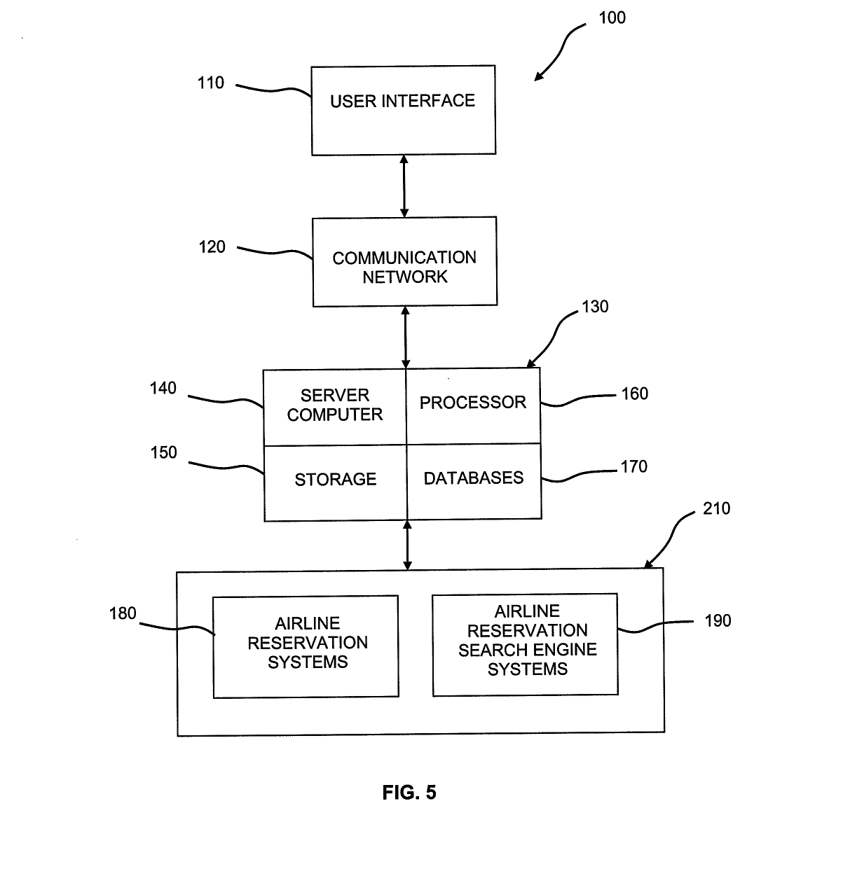

FIG. 5 shows an example architecture for a travel planning system for communicating, displaying, and processing travel reservations 100. The example architecture for the travel planning system 100 includes a user device 110. The user device is shown as a personal computer in FIG. 5, but it may also be a mobile phone, IP phone, a tablet device or any communication device that can connect to a Flight Saver System 130 via a network 120. The Flight Saver System 130 includes a server computer 140, including storage 150, a processor 160, and databases 170. The Flight Saver System 130 may be comprised of one or more personal computers, servers, an additional user device, and memory. The Flight Saver System 130 may provide access to a web site for travel reservation, or it may be accessed by other websites. The websites may include pages that include questions soliciting information regarding preferred origin location, destination location, date, time, number of tickets, class type, etc. The web storage 150 and databases 170 may store information that describes the content of the web site. The user device 110 may be used to provide responses to the questions, which may then be transmitted to the Flight Saver System 130. The Flight Saver System 130 may then determine, based on the responses to the questions, a list of potential flights that match the user's request. The Flight Saver System 130 may then transmit additional information back to the user device 110, related to the potential flights. The user device 110 may select flights and purchase or reserve tickets.

The Flight Saver System 130 is connected to an airline fare information system 210 that includes multiple airline reservation systems 180, each airline reservation system 180 being associated with one or more airlines. The airline fare information system 210 also includes multiple airline reservation search engine systems, resellers, or travel agencies 190, such as Kayak, Orbitz, or Travelocity.

The user device 110 may access the Flight Saver System 130 via one or more communication networks 120 which will display the website of the Flight Saver System 130 to a user of the user device 110. Through the user device 110, the user will be presented with questions regarding travel that are generated by the Flight Saver System 130.

The user device 110 may include a web browser, which may communicate data related to the web site to and from the Flight Saver System 130 via the communication network 120. The web browser may display data on one or more display devices (not depicted) that are included in or connected to the user device 110, such as a liquid crystal display (LCD) display or monitor. The user device 110 may receive input from the user from input devices (not depicted) that are included in or connected to the user device 110, such as a keyboard, a mouse, or a touch screen, and provide data that indicates the input to the web browser.

The user device 110 may transmit travel information to the Flight Saver System 130. The user may then submit the preferred travel information to the Flight Saver System 130. This information may include a preferred origin location, destination location, date, time, number of tickets, class type, etc.

The Flight Saver System 130 receives the preferred travel information via the server computer 140 and transmits a query to the airline fare information system 210 with the parameters of the preferred itinerary as selected by the user. The server computer 140 of the Flight Saver System 130 queries the airline fare information system 210 for both direct and indirect flights to the destination location.

The airline fare information system 210 determines which flights are available along with the flight times and associated fares and transmits the information back to the Flight Saver System. The Flight Saver System receives the flight information and identifies the lowest fare for the preferred itinerary regardless of whether the flight is direct from the preferred origin location to the destination location, if there are stops between the preferred origin location to the destination location, or if there is an itinerary leaving from the origin location to another location, wherein the destination location is an intermediate stop. For instance, for a preferred itinerary including origin location A and destination location B, the Flight Saver System can identify a cheaper fare from the airline fare information system 210 that includes an indirect flight from origin location A to destination location C with two flights in between from location A to location B and from location B to location C.

The Flight Saver System 130 determines a list of fares for the preferred itinerary, including both direct flights and partial indirect flights, and the processor 160 of the Flight Saver System 130 sorts the flights by price, flight duration, time of day, etc. The Flight Saver System 130 stores these fares in the memory storage 150 and then transmits these fares over the communication network 120 to the user device 110. The user device 110 displays the listed fares via a display. The user may then select, via the data entry device associated with the user device 110, which fare to purchase. The user may then transmit this selection over the communication network 120 to the Flight Saver System 130.

After confirming the price with the airline fare information system 210, the Flight Saver System 130 transmits a request to the user device 110 for a binding commitment to purchase a ticket. The user may then select to purchase the tickets via the data entry device associated with the user device 110. The purchase order is then transmitted to the Flight Saver System 130 which may be stored in the databases 170. The user's previous itineraries and searches may be stored in the databases 170 of the Flight Saver System 130.

While the embodiment provided above discloses a system for airline tickets, the system may be configured to plan travel using any ticketed methods of travel, including airlines, trains, buses, cruises, or any combination of travel.

Additionally, while the embodiment provided above discloses a system for directly selling tickets to a user, the system may also be adapted to communicate with a third party site and find itineraries for the third party site based on a user's input. In this embodiment, a user directly accesses a third party site, such as Kayak, Orbitz, or Travelocity. The user inputs a desired itinerary in a user device of the third party site. The third party site then contacts the Flight Saver System with the user's itinerary. The Flight Saver System transmits a query to an airline fare information system with the parameters of the preferred itinerary and queries the airline fare information system for both direct and indirect flights to the destination location. The airline fare information system determines available flights along with the flight times and associated fares and transmits the information back to the Flight Saver System. The Flight Saver System receives the flight information and identifies the lowest fare for the preferred itinerary regardless of whether the flight is direct from the preferred origin location to the destination location, if there are stops between the preferred origin location to the destination location, or if there is an itinerary leaving from the origin location to another location, wherein the destination location is an intermediate stop. The Flight Saver System determines a list of fares for the preferred itinerary, including both direct flights and partial indirect flights, and a processor of the Flight Saver System sorts the flights. The Flight Saver System then transmits these fares to the third party site which displays the listed fares to the user. The user may then select which fare to purchase and transmit this selection to the third party site.

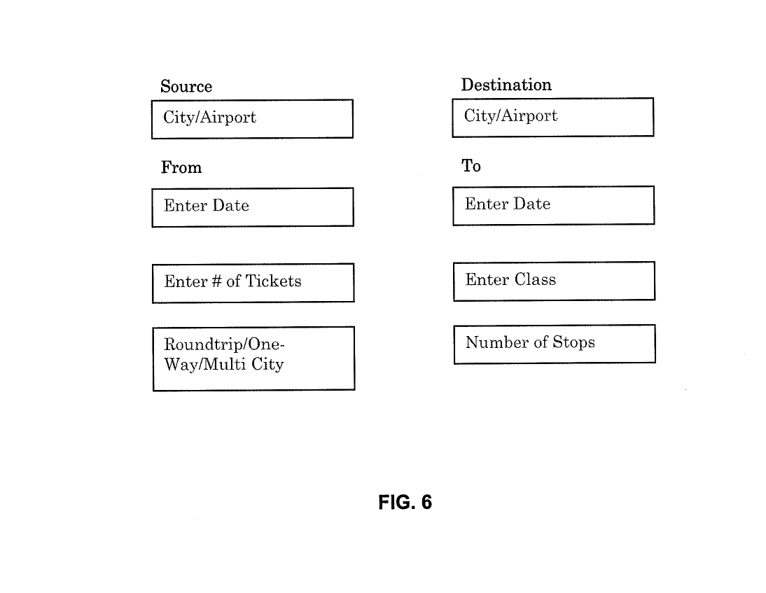

FIG. 6 shows a travel search form for the Flight Saver System 130. As shown in FIG. 6, the user is prompted to enter similar information as the typical reservation systems identified above as FIGS. 1 and 3. From this screen, the user may enter an origin and destination, travel dates, number of tickets, class type, whether the tickets are for round-trip, one-way, or multi-city tickets, and the number of acceptable stops. This information is then transmitted from the user device 110 to the Flight Saver System 130 via the network 120.

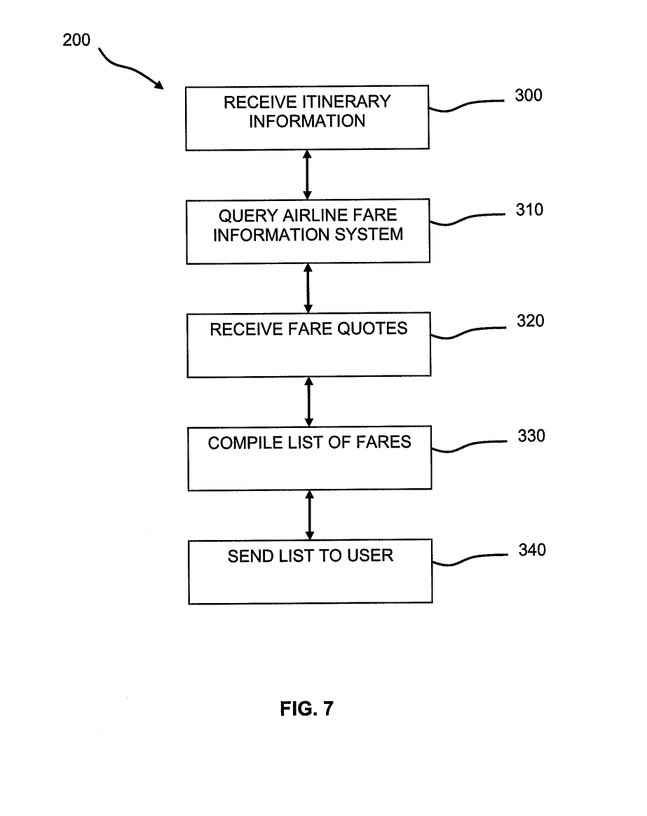

FIG. 7 shows an embodiment of a method for finding indirect flight fares 200. The method 200 is shown as a flow diagram according to an embodiment of the Flight Saver System 130. In step 300, the Flight Saver System 130 receives preferred itinerary information from the user device 110 through the network 120. The Flight Saver System 130 then queries the airline fare information system 210 in step 310. During step 310, the Flight Saver System 130 queries both indirect and direct flights between the origin location and destination location. The Flight Saver System 130 then receives fare quotes for the requested itinerary from the airline fare information system 210 in step 320. During step 330, the Flight Saver System 130 compiles a list of all of fares for the itinerary. The Flight Saver System 130 then sends the list to the user device 110 via the network 120 in step 340.

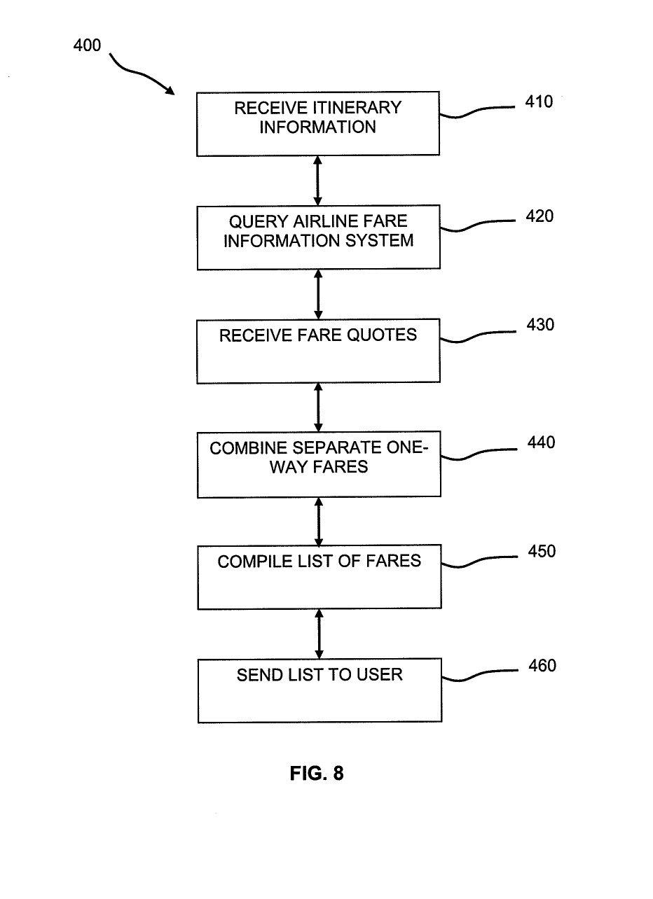

Because airline pricing models are based on demand, they may not prefer to allow users to select a round-trip ticket using the Flight Saver System. Some airlines may cancel a user's return flight in the event they miss one leg of the original flight. Accordingly, FIG. 8 is another embodiment of the method for finding indirect flights 400. As shown in FIG. 8, the Flight Saver System may receive requested itinerary information from the user 410. The Flight Saver System then queries the airline fare information system about the available flight times and rates for one-way trips 420. The Flight Saver System receives the fare quotes for the one-way trips 430. The Flight Saver System combines the one-way fares from one or more airlines 440; these combined one-way fares are then compiled into a list of fares 450. The list of fares is presented to the user 460. After which, the user has the option to select the preferred flights based on cost or schedule or airline.

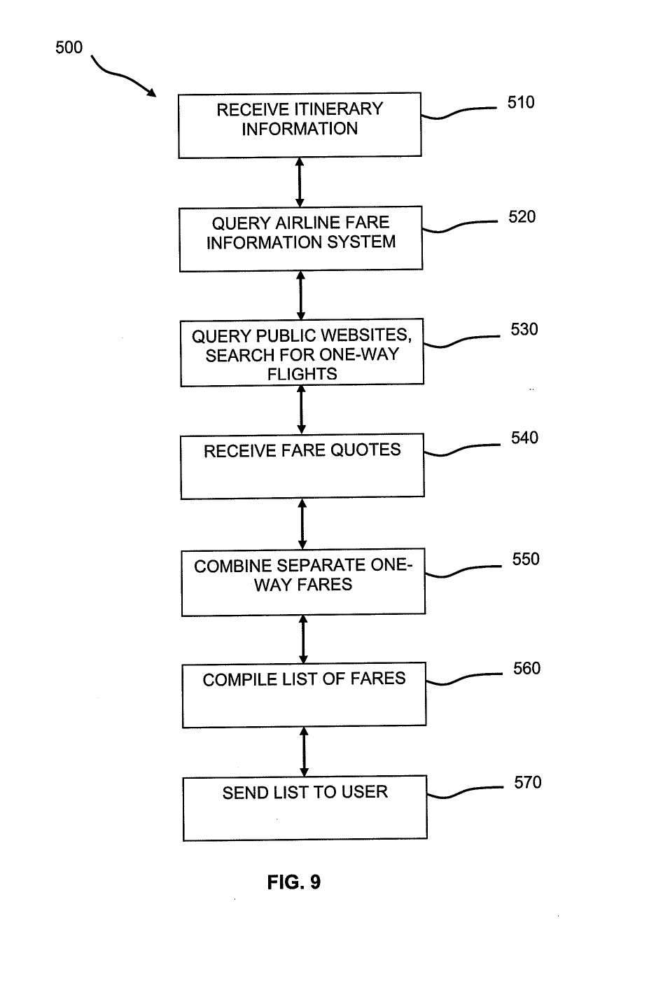

FIG. 9 shows another embodiment of the method for finding indirect flights 500. Some airlines may not make indirect flight information readily available. Accordingly, the Flight Saver System may be configured to communicate with other publically available websites to determine available flight schedules. The Flight Saver System may receive itinerary information 510. The Flight Saver System may then query airline fare information system for available flights 520. If the Flight Saver system determines that any of the airlines are blocked or unavailable, the Flight Saver System may query public websites for one-way flights, this may include sites such as Orbitz, Travelocity, Hotwire, or Priceline 530. The Flight Saver System receives the fare quotes for the one-way trips 540. The Flight Saver System then combines the one-way fares from one or more airlines 550. The combined one-way fares are compiled into a list of fares 560. The list of fares is then presented to the user 570. After which, the user has the options to select the preferred flights based on cost or schedule or airline.

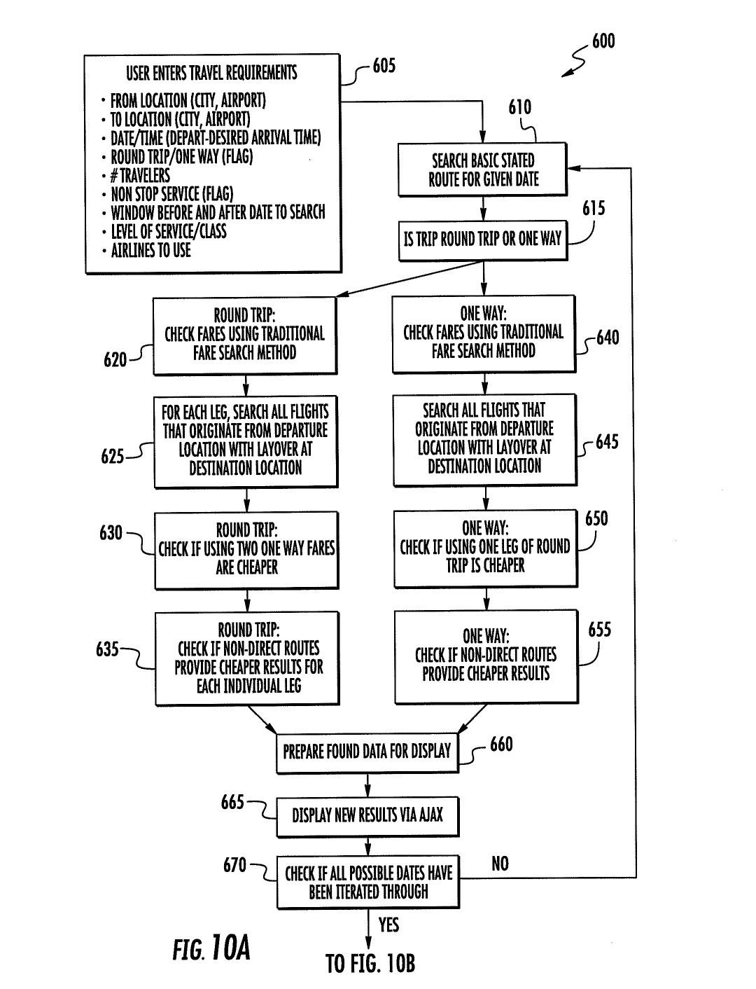

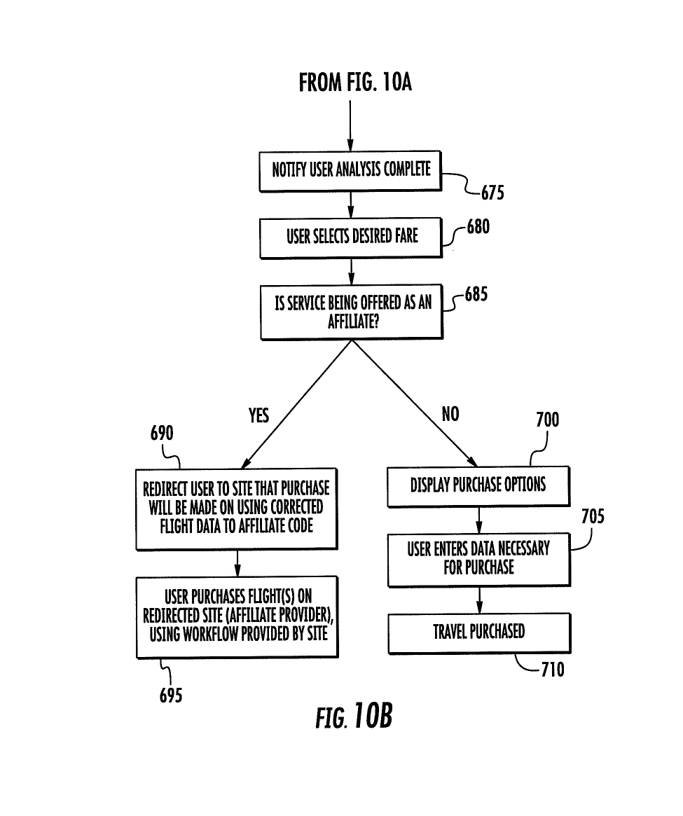

FIGS. 10a and 10b show a preferred embodiment of the process of purchasing tickets using the Flight Saver System 600. The process 600 includes an initial step 605 that includes the user entering travel information. The travel information includes: an origin city, destination city, date and time of departure, date and time of return, round trip or one way preference, number of travelers, non-stop service, travel windows before or after preferred date, and/or airlines. The search step 610 performs a basic search for the stated route and parameters for a given date. Next, the Flight Saver System determines if the requested trip is round trip or one way 615.

If the trip is round trip, fares are checked using a traditional fare searching method 620. For each leg of the trip, flights are searched that originate from the departure location with a layover in the destination location 625. Then the Flight Saver System checks if using two separate one way fares are cheaper than using a combined round trip booking 630. The Flight Saver System also checks if non-direct routes provide cheaper results for each individual leg 635.

If the trip is one way, fares are checked using a traditional fare searching method 640. Next, all the flights that originate from the departure location with a layover in the origin location are searched 645. Then the Flight Saver System checks if using one leg of a round trip is cheaper than using a round trip booking 650. The Flight Saver System checks if non-direct routes to provide cheaper results for each individual leg 655.

The Flight Saver System then prepares and compiles the data found through the searches 660. The results are then displayed to a user via a sortable displaying table 665, such as Ajax. The process then determines if all of the possible dates have been iterated through the search process 670. If all of the possible dates have not been run through the searching process, then the searching process is performed again until all of the possible dates have been searched. Once all of the possible searches are performed, a notification is sent to the user that indicates the analysis is complete 675. The user then selects a desired fare 680. The Flight Saver System then determines if the process is being iterated for a third party 685.

If the process is performed as an affiliate for a third party, then the user is redirected to a site that allows the user to purchase the tickets 690. The user then purchases the flights on the redirected site using the results from the Flight Saver System process 695.

The Flight Saver System does not have to offer the results to a third party and can instead display the ticket options directly to a user 700 via a website, mobile device application, or other interface. The user can then enter any necessary information to purchase the ticket, such as traveler information, payment information, and any other required information 705. The user then confirms the purchase and the ticket is booked 710.

When a user only uses a first leg of a flight, i.e. city A to city B, and the airline's itinerary is for city A to city C with an intermediate stop in city B, there will be an unused seat for the second leg of the flight, from city B to city C. The airline does not know about this unused seat until the plane is fully boarded and all the passengers are checked in. However, based on the user's itinerary, the Flight Saver System knows about the unused seat prior to the plane boarding. The Flight Saver System informs the airline that there will be an unused seat on the second leg of the flight. The Flight Saver System then charges the airline a commission or a flat fee for providing this information so that the airline can try to sell the unused seat. The Flight Saver System can also sell this information to a third party or affiliate. A portion of the money charged for selling the unused is then sent to the user as an incentive for using the Flight Saver System.

A user of the Flight Saver System can independently find a third party that is searching for a flight between the locations of the second leg of the flight, i.e. the unused seat. The user can then inform the third party that there will be an unused seat for the second leg of the flight. The third party buys the unused seat from the user of the Flight Saver System and the price of the unused seat can be split between the user, the Flight Saver System, and/or the airline.

The user of the Flight Saver System can refer a third party to use the Flight Saver System and the user then receives a portion of the money the airline charges for the third party's unused seat. This referral system incentivizes users to promote the Flight Saver System among third parties and encourages more flights to be booked by the Flight Saver System.

The Flight Saver System can also offer the user a variety of options when searching for fares. The Flight Saver System can allow the user to search for fares based on trip duration and time of day. Fares may also be searched based on amenities available during the trip, such as food options, alcohol availability, and other dietary and drink options. The Flight Saver System may also allow a user to search for fares based on the availability of power outlets, USB ports, and other technology related amenities. The Flight Saver System may also search for fares based on Wi-Fi availability, in-flight cellular use or other wireless options. Fares may also be searched based on which trip qualifies for the most frequent flyer miles.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A fare searching system comprising:
a receiver configured to receive a fare request from a user device, the fare request including at least a source location, a destination location, and a time of departure;
a transmitter configured to process the fare request and transmit a request for fare information regarding the fare request to an airline fare information system;
a processor configured to process and compile a first list of fares received from the airline fare information system, wherein the processor is also configured to generate a second list of fares including fares in which an intermediate location is the source location and/or the destination location, and the processor generates a combined list of fares based on the first and second lists; and
the transmitter transmits the combined list to the user device.

2. The fare searching system of claim 1, wherein the receiver receives a specified fare from the user device, and the processor books the specified fare.

3. The fare searching system of claim 1, wherein the processor determines if any additional locations are in geographic proximity to the source location or destination location, and the transmitter transmits additional requests for fare information including the additional locations to the airline fare information system.

4. The fare searching system of claim 1, wherein the processor determines if any additional dates are in temporal proximity to the time of departure, and the transmitter transmits additional requests for fare information including the additional times to the airline fare information system.

5. The fare searching system of claim 1, wherein the fare request includes a number of desired tickets, a one-way or round-trip option, number of intermediate stops between source location and destination location, and/or airline.

6. The fare searching system of claim 1, wherein the fare request is for a round trip, and the transmitter transmits a request for fare information regarding the fare request including one-way fares to an airline fare information system.

7. The fare searching system of claim 1, wherein the fare searching system formats data for the user device based on the user device platform.

8. The fare searching system of claim 1, wherein the fare request includes amenity information including food options and/or Wi-Fi.

9. A fare searching method comprising:
receiving a fare request from a user device, the fare request including at least a source location, a destination location, and a time of departure;
processing the fare request and transmitting the request for fare information regarding the fare request to an airline fare information system;
processing and compiling a first list of fares received from the airline fare information system;
generating a second list of fares including fares in which an intermediate location is the source location and/or the destination location;
generating a combined list of fares based on the first and second lists; and
sending the combined list to the user device.

10. The fare searching method of claim 9, wherein the receiver receives a specified fare from the user device, and the processor books the specified fare.

11. The fare searching method of claim 9, wherein the processor determines if any additional locations are in geographic proximity to the source location or destination location, and the transmitter transmits additional requests for fare information including the additional locations to the airline fare information system.

12. The fare searching method of claim 9, wherein the processor determines if any additional dates are in temporal proximity to the time of departure, and the transmitter transmits additional requests for fare information including the additional times to the airline fare information system.

13. The fare searching method of claim 9, wherein the fare request includes a number of desired tickets, a one-way or round-trip option, number of intermediate stops between source location and destination location, and/or airline.

14. The fare searching method of claim 9, wherein the fare request is for a round trip, and the transmitter transmits a request for fare information regarding the fare request including one-way fares to an airline fare information system.

15. The fare searching method of claim 9, wherein the fare searching system formats data for the user device based on the user device platform.

16. The fare searching method of claim 9, wherein the fare request includes amenity information including food options and/or Wi-Fi.
